(19) United States
(12) Patent Application Publication
(10) Pub. No.: US 2009/0159602 A1
(43) Pub. Date: Jun. 25, 2009

(54) Austenitic High Mn Stainless Steel for High Pressure Hydrogen Gas

(76) Inventors: Masaharu Hatano, Tokyo (JP); Akihiko Takahashi, Tokyo (JP)

Correspondence Address: KENYON & KENYON LLP, ONE BROADWAY, NEW YORK, NY, 10004, US

(21) Appl. No.: 12/084,305

(22) PCT Filed: Oct. 27, 2006
(86) PCT No.: PCT/JP2006/322030

§ 371 Date: Apr. 28, 2008

(30) Foreign Application Priority Data
Nov. 1, 2005 (JP) 2005-317908

(51) Int. Cl. F17C 1/00; C22C 38/58; C22C 38/20; C22C 38/44; F16L 9/02

(52) U.S. Cl. 220/581; 420/58; 420/60; 420/57; 420/61; 138/177

(57) ABSTRACT

The present invention proposes an austenitic high Mn stainless steel maintaining a hydrogen embrittlement resistance above that of SUS316L and adapted to a low temperature hydrogen environment by being designed in compositions to comprise, by mass %, C: 0.01 to 0.10%, N: 0.01 to 0.40%, Si: 0.1 to 1%, Cr: 10 to 20%, Mn: 6 to 20%, Cu: 2 to 5%, Ni: 1 to 6%, and a balance of Fe and unavoidable impurities and have an Md30 value of an indicator of an austenite stabilization degree satisfying −120<Md30<20, where Md30=497-462(C+N)-9.2Si-8.1Mn-13.7Cr-20(Ni+Cu)-18.5Mo

### TECHNICAL FIELD

The present invention relates to austenitic high Mn stainless steel superior in hydrogen embrittlement resistance used in a high pressure hydrogen gas environment and having superior mechanical properties (strength and ductility). Furthermore, the present invention relates to a high pressure hydrogen gas tank, high pressure hydrogen gas pipe, or other high pressure hydrogen gas equipment comprised of such austenitic high Mn stainless steel.

### BACKGROUND ART

In recent years, from the viewpoint of global warming, technology for using hydrogen as energy has come under the spotlight for suppressing the discharge of greenhouse gases (CO₂, NOx, and SOx). In the past, when storing hydrogen as a high pressure hydrogen gas, thick Cr—Mo steel tanks have been filled with hydrogen gas to a pressure of about 40 MPa.

However, this Cr—Mo steel tank falls in fatigue strength due to the fluctuations in internal pressure and the penetration of hydrogen when repeatedly charged with and discharging high pressure hydrogen, so the thickness has to be made 30 mm or so and consequently the weight swells. For this reason, the increase in weight and larger size of the facilities and equipment become serious problems.

On the other hand, existing SUS316-based austenite stainless steel has a hydrogen embrittlement resistance in a high pressure hydrogen gas environment better than that of other structural use steel, for example, the above carbon steel containing Cr—Mo steel or SUS304-based austenite stainless steel, so is being used for pipe materials and high pressure hydrogen fuel tank liners for fuel cell vehicles.

In the future, however, to store and transport large amounts of hydrogen gas, it will become necessary to raise the pressure of the hydrogen gas to over 40 MPa. In the case of SUS316 steel pipes, for use in a high pressure hydrogen gas environment of over 40 MPa, for example, the currently 3 mm thick pipes would have to be made 6 mm thick or more or else would not be able to withstand the pressure strength-wise. For this reason, even if using SUS316, with the current strength, an increase in weight and enlargement of facilities and equipment would be unavoidable. This is projected as becoming a major obstacle in practical use.

In the past, it was known that cold working increases the strength in austenite stainless steel. Therefore, the method of cold working the steel to increase the strength and thereby reduce the thickness may be considered. For example, Japanese Patent Publication (A) No. 5-98391 and Japanese Patent Publication (A) No. 7-216453 disclose increasing the strength and raising the fatigue strength of the material in austenite stainless steel by drawing, stretching, rolling, or other cold working. Furthermore, Japanese Patent Publication (A) No. 5-65601 and Japanese Patent Publication (A) No. 7-26350 disclose austenite stainless steel provided with both high strength and high fatigue strength by hot working at 1000° C. or less to build in a not yet recrystallized structure.

However, a worked structure resulting from the above cold working or a not yet recrystallized structure obtained by hot working remarkably drops in ductility and toughness and therefore has problems as structural members.

WO2004-111285 discloses high strength stainless steel reducing the drop in ductility and toughness of austenite stainless steel due to cold working and able to be used in a 70 MPa or higher high pressure hydrogen gas environment and a method of production of the same. However, this high strength stainless steel requires control of the texture of the worked structure to reduce the hydrogen embrittlement sensitivity due to cold working. As the method of production, for example, it is described to cold roll steel plate by 30% and further cold roll it by 10% in a direction perpendicular to this working direction. In the cold rolling process for normal industrial production of stainless steel, it is extremely difficult to change the working direction as explained above. Therefore, industrial production of the high strength stainless steel disclosed in this publication has become an issue.

“JRCM NEWS” (2003.10 No. 204, Japan Research and Development Center for Metals) shows the hydrogen environment embrittlement sensitivity evaluated from a tensile test under a hydrogen or helium gas atmosphere in an SUS316-based austenite stainless steel. From the results, the factor raising the embrittlement sensitivity in a low temperature hydrogen environment is the formation of strain-induced martensite accompanying working. Even in SUS316-based austenite stainless steel, it is clear that strain-induced martensite is formed and embrittlement occurs in a low temperature hydrogen environment. Furthermore, the results suggest the necessity to use SUS310S high Ni austenite stainless steel (19 to 22% Ni) to reduce the embrittlement in a low temperature hydrogen environment.

The inventors disclosed austenitic high Mn stainless steel having workability enabling cold working, deep drawing, and other press forming at a high working rate and maintaining nonmagnetization without the formation of strain-induced martensite in Japanese Patent Publication (A) No. 2005-154890 and WO2005-045082. These austenitic high Mn stainless steels have contents of Ni, for which costs have remarkably soared as materials in recent years, and are far superior in economy compared with the SUS316-based austenite stainless steel. However, these austenitic high Mn stainless steels are not intended for application to low temperature hydrogen environments. Their hydrogen embrittlement sensitivity has not been studied at all.

Therefore, as explained above, no austenite stainless steel suppressing the formation of strain-induced martensite in a low temperature hydrogen environment and superior in hydrogen embrittlement resistance exceeding SUS316 has yet appeared when considering the economy.

### DISCLOSURE OF THE INVENTION

The present invention was proposed to obtain austenite stainless steel suppressing the formation of strain-induced martensite in the above low temperature hydrogen environment and superior in hydrogen embrittlement resistance exceeding SUS316. It has as its object the provision of austenitic high Mn stainless steel suitable for a low temperature hydrogen environment by designing the compositions so that the Mn, Cu, N, and the Md30 value (° C.) of the indicator of the stabilization degree of the austenite satisfy the specific conditions in the austenitic high Mn stainless steel studied by the inventors up to now. Further, to achieve this object, there are provided:

(1) Austenitic high Mn stainless steel superior in hydrogen embrittlement resistance characterized by comprising, by mass %, C: 0.01 to 0.10%, N: 0.01 to 0.40%, Si: 0.1 to 1%, Cr: 10 to 20%, Mn: 6 to 20%, Cu: 2 to 5%, Ni: 1 to 6%, and a balance of Fe and unavoidable impurities and having an Md30 value of an indicator of an austenite stabilization degree satisfying the following formula (A):

−120<Md30<20 (A)
where, Md30(° C.): 551-462(C+N)-9.2Si-8.1Mn-13.7Cr-29(Ni+Cu)-18.2Mo

(2) Austenitic high Mn stainless steel superior in hydrogen embrittlement resistance as set forth in (1) characterized by further containing, by mass %, Mo: 0.3 to 3.0%.

(3) A high pressure hydrogen gas tank storing hydrogen gas of a pressure of 120 MPa or less, said high pressure hydrogen gas tank characterized in that the body and/or liner of said gas tank is comprised of austenitic high Mn stainless steel as set forth in (1) or claim (2).

(4) A high pressure hydrogen gas pipe transporting hydrogen gas of a pressure of 120 MPa or less, said high pressure hydrogen gas pipe characterized in that said pipe is comprised of austenitic high Mn stainless steel as set forth in (1) or (2).

As explained above, the austenitic high Mn stainless steel of the present invention employs the composition design of C: 0.01 to 0.10%, N: 0.01 to 0.40%, Si: 0.1 to 1%, Cr: 10 to 20%, Mn: 6 to 20%, Cu: 2 to 5%, Ni: 1 to 6%, −120<Md30<20, whereby it is possible to suppress the formation of strain-induced martensite in a low temperature hydrogen environment and reduce the hydrogen embrittlement sensitivity down to a degree comparable to SUS310S.

Therefore, application to low temperature hydrogen environments, which was difficult in the past with SUS316-based austenite stainless steel, becomes possible. The invention may be used as a body of high pressure hydrogen gas tanks storing hydrogen gas of a pressure of over 40 MPa, structural members of liners of high pressure hydrogen gas tanks, or materials for high pressure hydrogen gas pipes transporting hydrogen gas. Further, low Ni content austenitic high Mn stainless steel is far superior in economy compared with SUS316-based austenite stainless steel.

### BRIEF DESCRIPTION OF THE DRAWINGS

FIG. 1 is a graph showing the effect of addition of Mn on the formation of strain-induced martensite accompanying working.

FIG. 2 is a graph showing the effect of addition of Mn on the hydrogen embrittlement resistance.

FIG. 3 is a graph showing the effect of addition of N on the strength.

### BEST MODE FOR CARRYING OUT THE INVENTION

The austenitic high Mn stainless steel of the present invention employs an composition design where the Mn, Cu, N, and Md30 value (° C.) of the indicator of the austenite stabilization degree satisfy suitable ranges and thereby realizes a hydrogen embrittlement resistance exceeding that of a SUS316-based austenite stainless steel.

Below, the actions and effects of the compositions of the austenitic high Mn stainless steel of the present invention and the reasons for limiting the ranges of content will be explained.

(Mn: 6 to 20%)

It is well known that Mn effectively acts as an austenite stabilizing element in place of Ni. The inventors threw light on the details of the deformed structure and obtained the following discoveries relating to the action and effects of Mn and Ni on the formation of strain-induced martensite:

(1) In low Ni austenite steel with an amount of Ni of 1 to 6%, if adding Mn, the formation of strain-induced martensite accompanying working is greatly suppressed.

(2) The effect of suppression of strain-induced martensite of (1) is extremely large compared with the 300-series austenite stainless steel (SUS304, SUS316, etc.) with an equivalent Md30 value (° C.) of the indicator of the austenite stabilization degree.

(3) In high Mn steel with Mn added, plastic deformation proceeds due to the slip deformation of the austenite at the time of working. If the nominal strain exceeds 0.2, twinning deformation follows. For this reason, high Mn steel is susceptible to formation of strain-induced martensite due to working.

(4) Plastic deformation accompanied with twinning deformation easily occurs in the case of an amount of Mn of 6% or more without the deformed structure, that is, the strain-induced martensite, of (3).

(5) High Mn steel in which strain-induced martensite is not formed realizes a hydrogen embrittlement resistance exceeding SUS316 in a low temperature hydrogen environment.

In the present invention, to obtain the above-mentioned action and effects, Mn is added in an amount of 6% or more, more preferably 8% or more. On the other hand, there is the problem that the addition of Mn causes an increase in the S-based inclusions and detracts from the ductility and toughness or corrosion resistance of the steel material. Therefore, the upper limit is made 20%, preferably 15% or less.

(Cu: 2 to 5%)

Cu is an austenite stabilizing element. It is known to be an element effective for improving the cold workability and corrosion resistance as well. In the high Mn steel of the present invention, Cu is an element facilitating twinning deformation by the synergistic effect with Mn and effectively suppressing the formation of strain-induced martensite from the viewpoint of the above-mentioned deformed structure. In the present invention, to obtain these actions and effects, over 2% of Cu is added. However, if adding a large amount of Cu, there are the problems that Cu contamination and hot embrittlement are induced at the time of steelmaking and the ductility and toughness of the steel material are inhibited. Therefore, the upper limit of Cu is made 5%.

(N: 0.01 to 0.40%)

N is an element effective for stabilization of the austenitic phase and suppression of the formation of the 8-ferritic phase. Furthermore, it is known that N causes a rise in the 0.2% yield strength and tensile strength of steel materials by solution strengthening. The addition of N is effective for increasing the strength of the high Mn steel of the present invention as well. That is, the addition of N can give strength as a structural material even without working, so is an effective means for reducing the thickness and lightening the weight of equipment.

In the present invention, to obtain the above-mentioned action and effect, N is added in some cases. In this case, 0.1 to 0.40% is preferable. Addition of N over 0.40% is difficult in an ordinary melting process. In addition to the large rise in the steelmaking cost, the excessive rise in strength causes a drop in the ductility of the steel material. For this reason, the upper limit of N is made 0.40%, more preferably 0.30% or less. Further, when it is not necessary to add N, that is, when making the steel material higher in strength, the lower limit of N is made 0.01%. If making N less than 0.01%, in addition to the burden of the steelmaking costs, it becomes difficult to satisfy the Md30 value defined by the present invention.

(Indicator of Austenite Stabilization Degree: Md30 Value (° C.))

Metastable austenite stainless steel undergoes a martensitic transformation by plastic working even at a temperature of the Ms point or more. The upper limit temperature where the transformation point occurs due to working is called the “Md value”. That is, the Md value is an indicator showing the stabilization degree of austenite. Further, the temperature at which 50% martensite is formed when giving a strain of 30% by tensile deformation is called the Md30 value.

By designing the Md30 value (° C.) defined as Md30=497-462(C+N)-9.2Si-8.1Mn-13.7Cr-20(Ni+Cu)-18.5Mo to be in the range of −120° C. to 20° C. in the high Mn stainless steel of the present invention, the inventors discovered that the strain-induced martensite can be suppressed and the hydrogen embrittlement resistance can be secured as targeted by the present invention.

When the Md30 value is smaller than −120° C., an increase in alloying or increase in N causes a drop in the ductility of the steel material and obstructs workability. On the other hand, if the Md30 value is over 20° C., strain-induced martensite is easily formed and the hydrogen embrittlement resistance is reduced. If the Md30 value is −120 to 20° C., the high Mn stainless steel (Mn: 6 to 20%) of the present invention suppresses the formation of strain-induced martensite in a low temperature hydrogen environment and realizes a hydrogen embrittlement resistance of over SUS316.

The high Mn stainless steel adjusted to an Mn: 6 to 20%, Cu: 2 to 5%, N: 0.01 to 0.40%, and Md30 value: −120 to 20° C. of the present invention suppresses the formation of strain-induced martensite in a low temperature hydrogen environment and realization of a hydrogen embrittlement resistance over SUS316. Further, the other alloy elements of the present invention other than Mn, Cu, and N are selected in the following ranges as explained below:

(C: 0.01 to 0.10%)

C is an Element Effective for Stabilization of the austenitic phase and suppression of formation of the δ-ferritic phase. Further, C, in the same way as N, has the effect of raising the 0.2% yield strength and tensile strength of steel materials by solution strengthening. However, C sometimes has a detrimental effect on the ductility and toughness or corrosion resistance due to the M23C6 type carbides (M: Cr, Mo, Fe, etc.) and MC type carbides (M: Ti, Nb, etc.) in the austenite stainless steel. For this reason, the upper limit of C is made 0.10%. The lower limit is made 0.01%. If making N less than 0.01%, in addition to the burden of the steelmaking costs, it becomes difficult to satisfy the Md30 value defined by the present invention.

(Si: 0.1 to 1%)

Si is effective as a deoxidizing agent at the time of melting. To obtain this effect, 0.1% or more is added, more preferably 0.3% or more. If making Si less than 0.1%, the deoxidation becomes difficult and, further, it becomes possible to satisfy the Md30 value defined by the present invention. On the other hand, Si is an element effective for solution strengthening. For this reason, this is sometimes added for giving strength as a structural material of the present invention. However, addition of Si sometimes promotes the formation of a sigma phase or other intermetallic compounds and reduces the hot workability or the ductility and toughness of the steel material. For this reason, the upper limit is made 1%.

(Cr: 10 to 20%)

Cr is an alloy element essential for obtaining the corrosion resistance required from stainless steel. 10% or more is required, preferably 12% or more. Further, if making Cr less than 10%, it becomes difficult to satisfy the Md30 value defined by the present invention. On the other hand, if excessively adding Cr, CrN, Cr₂N, and other nitrides and M23C6-type carbides are formed and the ductility and toughness of the steel material are sometimes detrimentally affected. For this reason, the upper limit of Cr is 20% or less, preferably 15% or less.

(Ni: 1 to 6%)

Ni is an expensive element. 300-series austenite stainless steel with over 6% invites a rise in the material costs. Therefore, in the case of the high Mn steel of the present invention, Ni is 6% or less, preferably 5% or less. Ni is an element necessary for austenite stainless steel. Further, it is an element effective for suppressing the formation of strain-induced martensite accompanying working. For this reason, the lower limit is made 1%.

(Mo: 0.3% to 3%)

This is an element effective for improvement of the corrosion resistance. Further, it is an element effective for reducing the Md30 value defined by the present invention. For this reason, Mo is preferably added to obtain these effects. In this case, the lower limit of Mo is made 0.3%. However, if Mo is excessively included, it will invite a remarkable rise in the material costs, so the content is made 3% or less.

The austenitic high Mn stainless steel employing the above-mentioned composition design suppresses the formation of strain-induced martensite in a low temperature hydrogen environment. It is used as the body of high pressure hydrogen gas tanks of a pressure of over 40 MPa, difficult for SUS316-based austenite stainless steel, structural materials for liners of high pressure hydrogen gas tanks, or a material for high pressure hydrogen gas pipes for transporting hydrogen gas. While this can also be used for pressure vessels of over 120 MPa, this sort of vessel is not required much at all in structural design, so the upper limit of the pressure is made 120 MPa.

### EXAMPLES

The inventors produced stainless steel having each of the chemical compositions of Table 1 and produced hot rolled plates of a plate thickness of 5.0 mm by hot rolling at a hot rolling temperature 1200° C. The inventors annealed the hot rolled plates at 1120° C. for a soaking time of 2 minutes and pickled them to obtain 5.0 mm thick hot rolled annealed plates. Furthermore, they cold rolled these hot rolled annealed plates to plate thicknesses of 2.0, annealed them at 1080° C. for a soaking time of 30 seconds, and pickled them to prepare 2.0 mm thick cold rolled annealed plates.

The inventors prepared JIS 13B tensile test pieces from 2.0 mm thick cold rolled annealed plate and ran tensile tests in the atmosphere and in 45 MPa, 90 MPa, and 120 MPa high pressure hydrogen gas. The hydrogen embrittlement sensitivity was evaluated by (1) the volume ratio of strain-induced martensite formed after high pressure (120 MPa) hydrogen gas and (2) the elongation (in high pressure hydrogen gas)/elongation (in the atmosphere). The volume ratio of strain-induced martensite was measured using a commercially available ferrite scope MC3C. Here, the test atmosphere temperature is −50 to −100° C. in high pressure hydrogen gas and room temperature (20° C.) in the atmosphere.

The chemical compositions of the tested steels and the results of evaluation of the Md30 value and above-mentioned hydrogen embrittlement sensitivities (1) and (2) are shown in Table 1.

Steel Nos. 1 to 8 satisfy the conditions of the composition design of austenitic high Mn stainless steel defined by the present invention. They suppress the formation of strain-induced martensite in high pressure hydrogen gas and exhibit almost no drop in elongation (ductility and toughness) in 45 to 120 MPa high pressure hydrogen gas. That is, the high Mn stainless steel of the present invention obtains a hydrogen embrittlement resistance better than the comparative SUS316L of No. 23.

Steel Nos. 9 to 21 had one or both of the amount of Mn and other compositions defined by the present invention and the Md30 value outside the conditions defined by the present invention, so failed to give the hydrogen embrittlement resistance targeted in the present invention.

Steel Nos. 9, 11, 13, 15, 17, 19, 21, and 22 have small amounts of Mn or amounts of Cu or large Md30s, were susceptible to formation of strain-induced martensite in hydrogen gas, and failed to give the ductility and toughness targeted in high pressure hydrogen gas.

Steel Nos. 10, 12, 14, 16, 18, and 20 had small Md30s and suppressed formation of strain-induced martensite in high pressure hydrogen gas, but had C, N, and other elements outside the range of compositions defined by the present invention and failed to give the ductility and toughness targeted in high pressure hydrogen gas.

TABLE 1

| | | | | | | | | | | | Hydrogen embrittlement | | | | |
|---|---|---|---|---|---|---|---|---|---|---|---|---|---|---|---|
| | | | | | | | | | | | sensitivity | | | | |
| | | Chemical composition(mass %) | | | | | | | | | α′ | EL/ | EL/ | EL/ | |
| Steel No. | | C | Si | Mn | Ni | Cr | Mo | Cu | N | Md30 | (%) | 45 MPa | 90 MPa | 120 MPa | Remarks |
| 1 | Inv. | 0.065 | 0.50 | 8.8 | 5.8 | 14.5 | 0.35 | 2.5 | 0.040 | −19.1 | 0.5 | 0.95 | 0.90 | 0.90 | |
| 2 | ex. | 0.065 | 0.50 | 8.7 | 4.8 | 14.5 | 0.35 | 2.5 | 0.040 | 10.7 | 0.5 | 0.90 | 0.90 | 0.90 | |
| 3 | | 0.065 | 0.50 | 14.5 | 4.8 | 14.5 | 0.35 | 2.5 | 0.040 | −36.3 | 0.0 | 0.95 | 0.90 | 0.85 | |
| 4 | | 0.065 | 0.50 | 8.7 | 4.8 | 14.5 | 0.35 | 2.5 | 0.100 | −17.0 | 0.5 | 0.90 | 0.85 | 0.85 | |
| 5 | | 0.065 | 0.50 | 8.7 | 4.8 | 14.5 | 0.35 | 2.5 | 0.200 | −63.2 | 0.0 | 0.90 | 0.90 | 0.90 | |
| 6 | | 0.065 | 0.50 | 8.7 | 4.8 | 14.5 | 0.35 | 2.5 | 0.300 | −109.4 | 0.0 | 0.95 | 0.90 | 0.90 | |
| 7 | | 0.065 | 0.50 | 14.5 | 5.5 | 14.5 | 0.10 | 2.2 | 0.040 | −43.3 | 1.0 | 0.90 | 0.90 | 0.85 | |
| 8 | | 0.085 | 0.45 | 11.5 | 4.6 | 17.8 | 0.10 | 2.0 | 0.200 | −115.0 | 0.0 | 0.90 | 0.85 | 0.85 | |
| 9 | Comp. | 0.060 | 0.50 | 5.2 | 4.5 | 14.5 | 0.35 | 2.5 | 0.040 | 50.1 | *9.0 | *0.7 | *0.5 | *0.5 | Small Mn |
| 10 | ex. | 0.060 | 0.50 | 21.0 | 4.5 | 14.5 | 0.35 | 2.5 | 0.040 | −77.9 | 0.0 | *0.7 | *0.6 | *0.5 | Large Mn |
| 11 | | 0.070 | 0.50 | 8.8 | 4.8 | 15.8 | 0.30 | 1.5 | 0.045 | 17.4 | *3.0 | *0.7 | *0.6 | *0.5 | Small Cu |
| 12 | | 0.070 | 0.50 | 8.8 | 4.8 | 15.8 | 0.10 | 5.5 | 0.045 | −95.0 | 0.0 | *0.7 | *0.6 | *0.5 | Large Cu |
| 13 | | 0.060 | 0.50 | 8.6 | 4.8 | 14.5 | 0.10 | 2.2 | 0.040 | 27.1 | *5.0 | *0.7 | *0.6 | *0.5 | Large Md30 |
| 14 | | 0.130 | 0.50 | 10.0 | 3.0 | 16.5 | 0.34 | 2.0 | 0.082 | −9.8 | 2.0 | *0.6 | *0.6 | *0.5 | Large C |
| 15 | | 0.003 | 0.45 | 14.5 | 4.5 | 14.0 | 0.10 | 2.0 | 0.040 | 27.4 | *8.0 | *0.5 | *0.5 | *0.5 | Small C, Large Md30 |
| 16 | | 0.085 | 0.45 | 11.5 | 5.8 | 17.8 | 0.10 | 2.0 | 0.450 | −265.3 | 0.0 | *0.6 | *0.4 | *0.4 | Large N, small Md30 |
| 17 | | 0.065 | 0.50 | 11.5 | 4.8 | 14.5 | 0.10 | 2.0 | 0.003 | 24.2 | *10 | *0.5 | *0.4 | *0.4 | Small N, Large Md30 |
| 18 | | 0.065 | 1.50 | 11.5 | 4.2 | 14.5 | 0.10 | 2.0 | 0.040 | 15.3 | 2.0 | *0.7 | *0.6 | *0.5 | Large Si |
| 19 | | 0.065 | 0.05 | 8.8 | 4.8 | 14.5 | 0.10 | 2.0 | 0.040 | 33.1 | *7.0 | *0.6 | *0.6 | *0.5 | Small Si, Large Md30 |
| 20 | | 0.065 | 0.50 | 9.0 | 5.0 | 22.0 | 0.30 | 2.0 | 0.040 | −84.9 | 0.0 | *0.65 | *0.6 | *0.5 | Large Cr |
| 21 | | 0.065 | 0.50 | 10.0 | 5.5 | 9.5 | 0.30 | 3.0 | 0.040 | 34.8 | *7.5 | *0.6 | *0.6 | *0.5 | Small Cr, Large Md30 |
| 22 | | 0.065 | 0.50 | 9.5 | 0.5 | 15.5 | 0.30 | 1.5 | 0.120 | 108.2 | *30 | *0.4 | *0.3 | *0.3 | Small Ni, Large Md30 |
| 23 | | 0.015 | 0.60 | 1.0 | 12.0 | 17.5 | 2.00 | 0.2 | 0.015 | −106.4 | *10 | *0.8 | *0.8 | *0.8 | Large Ni, SUS316L |

Md30 = 551 − 462(C + N)—9.2Si—8.1Mn—13.7Cr—29(Ni + Cu)—18.2Mo
α′: Volume rate of α′ formed after tensile test in 120 MPa hydrogen gas, target <2.0%
EL/45 MPa: Elongation (in 45 Mpa hydrogen gas)/elongation (in atmosphere), EL/90 MPa: Elongation (in 90 Mpa hydrogen gas/elongation (in atmosphere), EL/120 MPa: elongation (in 120 MPa hydrogen gas)/elongation (in atmosphere), in hydrogen gas: −50 to −100° C., in atmosphere: room temperature (20° C.), target EL/45, 90, 120 MPa > 0.8
Underlines of values: Shows outside scope of present invention.
*Shows hydrogen embrittlement sensitivity of austenitic high Mn stainless steel targeted by the present invention not yet reached.

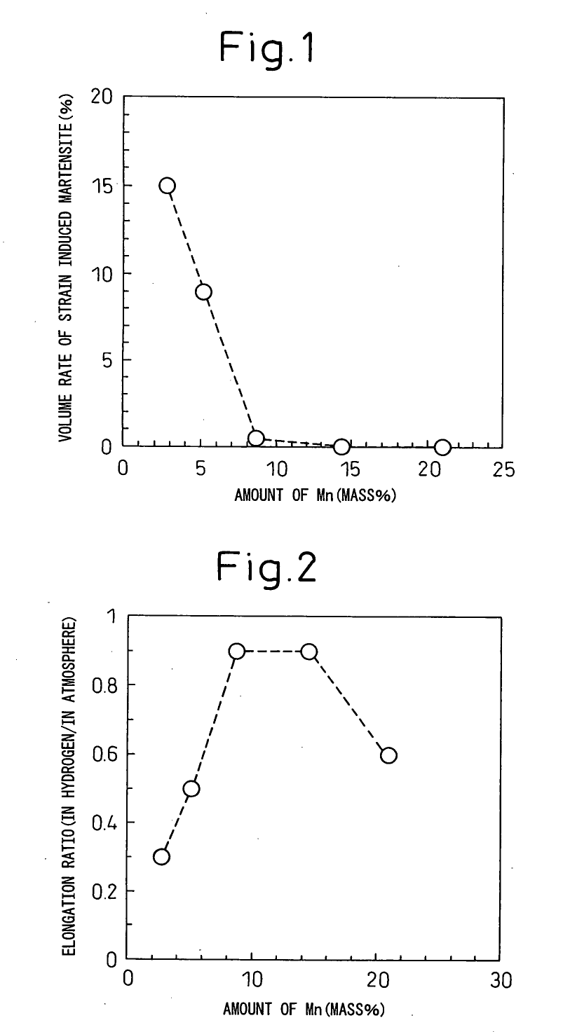

The inventors investigated the amount of Mn and the amount of formation of strain-induced martensite formed in a tensile test in 90 MPa hydrogen gas in the range of the Md30 value defined by the present invention. The results are shown in FIG. 1. They could confirm that by addition of an amount of 6% or more of Mn, the formation of strain-induced martensite is effectively suppressed.

Further, they studied the relationship between the addition of Mn and the ductility in 90 MPa hydrogen gas. As a result, they were able to confirm, as shown in FIG. 2, that by making 6≦Mn≦20, the ductility (toughness) targeted by the present invention can be obtained.

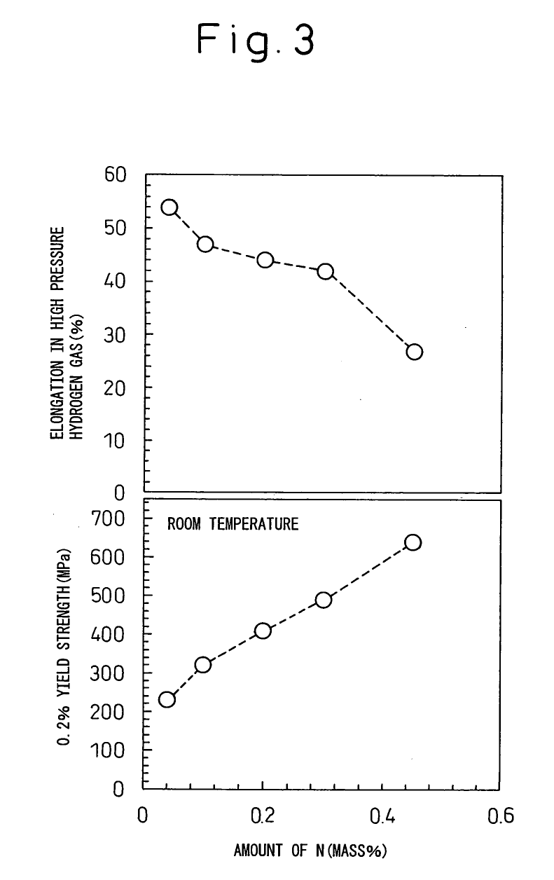

Furthermore, the inventors investigated the relationship between the addition of N and the strength in the range of the compositions and Md30 value defined by the present invention. As a result, they could confirm that, as shown in FIG. 3, by making 0.1≦N<0.40, the drop in ductility (toughness) in 90 MPa hydrogen gas is suppressed and the strength is increased.

### INDUSTRIAL APPLICABILITY

The austenitic high Mn stainless steel of the present invention gives a hydrogen embrittlement resistance higher than SUS316L, so is used as a material for a low temperature hydrogen environment—which was difficult with SUS316-based austenite stainless steel. This can be applied as a material for a high pressure hydrogen gas tank storing hydrogen gas of a pressure of over 40 MPa, a high pressure hydrogen gas tank liner, or a high pressure hydrogen gas pipe transporting hydrogen gas. Further, low Ni content austenitic high Mn stainless steel is extremely superior in economy compared with SUS316-based austenite stainless steel.

1. Austenitic high Mn stainless steel superior in hydrogen embrittlement resistance used in high pressure hydrogen gas environment, said austenitic high Mn stainless steel characterized by comprising, by mass %, C: 0.01 to 0.10%, N: 0.01 to 0.40%, Si: 0.1 to 1%, Cr: 10 to 20%, Mn: 6 to 20%, Cu: 2 to 5%, Ni: 1 to 6%, and a balance of Fe and unavoidable impurities and having an Md30 value of an indicator of an austenite stabilization degree satisfying the following formula (A):
−120<Md30<20 (A)
where, Md30(° C.): 551-462(C+N)-9.2Si-8.1Mn-13.7Cr-29(Ni+Cu)-18.2Mo.

2. Austenitic high Mn stainless steel superior in hydrogen embrittlement resistance as set forth in claim 1 characterized by further containing, by mass %, Mo: 0.3 to 3.0%.

3. A high pressure hydrogen gas tank storing hydrogen gas of a pressure of 120 MPa or less, said high pressure hydrogen gas tank characterized in that the body and/or liner of said gas tank is comprised of austenitic high Mn stainless steel as set forth in claim 1.

4. A high pressure hydrogen gas pipe transporting hydrogen gas of a pressure of 120 MPa or less, said high pressure hydrogen gas pipe characterized in that said pipe is comprised of austenitic high Mn stainless steel as set forth in claim 1.
